(19) United States
(12) Patent Application Publication
(10) Pub. No.: US 2023/0076962 A1
(43) Pub. Date: Mar. 9, 2023

(54) CORRECTION OF LIGHT DISTRIBUTION FOR LIDAR WITH DETECTOR ARRAY

(71) Applicant: BEIJING VOYAGER TECHNOLOGY CO., LTD., Beijing (CN)

(72) Inventors: Youmin Wang, Berkeley, CA (US); Yue Lu, Mountain View, CA (US)

(73) Assignee: BEIJING VOYAGER TECHNOLOGY CO., LTD., Beijing (CN)

(21) Appl. No.: 17/468,514

(22) Filed: Sep. 7, 2021

(51) Int. Cl. G01S 7/481; G02B 27/09; G02B 3/04

(52) U.S. Cl. CPC G01S 7/4817; G02B 27/0927; G02B 27/0955; G02B 3/04

(57) ABSTRACT

Embodiments of the disclosure provide an optical sensing system containing a conical lens pair, and an optical sensing method using the same. For example, the optical sensing system includes a transmitter configured to emit an optical signal toward an environment surrounding the optical sensing system. The transmitter includes a laser emitter configured to emit the optical signal, a beam shaper configured to receive the optical signal emitted by the laser emitter and redistribute a light intensity of the received optical signal away from a center of the optical signal, and a steering device configured to receive the redistributed optical signal output from the beam shaper and direct the redistributed optical signal toward the environment. The optical sensing system further includes a receiver configured to receive the optical signal returning from the environment.

### TECHNICAL FIELD

The present disclosure relates to a light detection and ranging (LiDAR) system, and more particularly, to a beam shaper including conical lens pair for redistributing a laser beam emitted by a laser emitter in the LiDAR system.

### BACKGROUND

In a LiDAR system, the size of a laser beam determines the imaging resolution. A decreased laser beam size may result in an increased imaging resolution. However, the size of an emitted laser beam cannot indefinitely decrease, and thus there is a size limitation of an emitted laser beam, which then limits the imaging resolution. A detector array in a receiving end of a LiDAR system may allow sub-pixelization to be achieved, to increase the imaging resolution. In such a LiDAR system, a returning laser beam may be detected by a plurality of photodetectors or photosensors in the detector array, where each photodetector or photosensor merely detects a section of the returning laser beam at a sublocation. Since each section has a much smaller beam size, the imaging resolution may be further improved.

However, in existing LiDAR systems, a returning light beam is not uniformly distributed. That is, in different sections detected a photodetector array, the detected returning light beams may have different intensities. One possible reason is that a laser beam emitted by a laser emitter itself is not uniformly distributed. Another reason is the Lambertian effect that is inherent in light reflection. Due to the Lambertian effect, a reflected laser beam may have a higher light intensity in one direction (e.g., when the incident angle is 0 degree) than another direction (e.g., when the incident angle is large). The nonuniform distribution of the reflected laser beam could result in a weaker/lost signal in certain channels of a photodetector array, and thus distorted imaging may occur in sub-pixelization in these LiDAR systems.

Embodiments of the disclosure address the above problems by including a conical lens pair in a transmitter of a LiDAR system to redistribute an emitted laser beam, so that a more uniform laser beam can be received by a photodetector array in the LiDAR system.

### SUMMARY

Embodiments of the disclosure provide an exemplary optical sensing system. The optical sensing system includes a transmitter configured to emit an optical signal toward an environment surrounding the optical sensing system. The transmitter includes a laser emitter configured to emit the optical signal, a beam shaper configured to receive the optical signal emitted by the laser emitter and redistribute a light intensity of the received optical signal away from a center of the optical signal, and a steering device configured to receive the redistributed optical signal output from the beam shaper and direct the redistributed optical signal toward the environment. The optical sensing system further includes a receiver configured to receive the optical signal returning from the environment.

Embodiments of the disclosure further provide an exemplary optical sensing method. The method includes emitting, by a laser emitter of an optical sensing system, an optical signal toward an environment of the optical sensing system. The method further includes redistributing, by a beam shaper of the optical sensing system, a light intensity of the received optical signal emitted by the laser emitter away from a center of the optical signal. The method additionally includes directing, by a steering device of the optical sensing system, the redistributed optical signal toward the environment. The method additionally includes receiving, by a receiver of the optical sensing system, the optical signal returning from the environment. Here, the beam shaper includes a conical lens pair aligned in tandem along a light path of the optical signal, and the receiver includes a photodetector array for detecting the returning optical signal.

Embodiments of the disclosure additionally provide an exemplary transmitter for an optical sensing system. The transmitter includes a laser emitter configured to emit an optical signal. The transmitter further includes a beam shaper configured to receive the optical signal emitted by the laser emitter and redistribute a light intensity of the received optical signal away from a center of the optical signal. The transmitter additionally includes a steering device configured to receive the redistributed optical signal output from the beam shaper and direct the redistributed optical signal toward an environment.

It is to be understood that both the foregoing general description and the following detailed description are exemplary and explanatory only and are not restrictive of the present disclosure, as claimed.

### BRIEF DESCRIPTION OF THE DRAWINGS

FIG. 1 illustrates a schematic diagram of an exemplary vehicle equipped with a LiDAR system containing a conical lens pair, according to embodiments of the disclosure.

FIG. 2 illustrates a block diagram of an exemplary LiDAR system containing a conical lens pair, according to embodiments of the disclosure.

FIG. 3 illustrates a schematic diagram of an exemplary scenario of a laser beam emitted onto a far-field object, according to embodiments of the disclosure.

FIG. 4A illustrates an exemplary light intensity profile of a returned laser beam in a LiDAR system without a conical lens pair, according to embodiments of the disclosure.

FIG. 4B illustrates an exemplary light intensity profile of an emitted laser beam in a LiDAR system containing a conical lens pair, according to embodiments of the disclosure.

FIG. 5 illustrates a schematic diagram showing an exemplary laser intensity redistribution effect caused by a conical lens pair, according to embodiments of the disclosure.

FIG. 6 illustrates a schematic diagram of an exemplary biaxial LiDAR system containing a conical lens pair, according to embodiments of the disclosure

FIG. 7 illustrates a schematic diagram of an exemplary coaxial LiDAR system containing a conical lens pair, according to embodiments of the disclosure.

FIG. 8 is a flow chart of an exemplary optical sensing method of a LiDAR system containing a conical lens pair, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

Embodiments of the present disclosure provide a beam shaper in a transmitter of a LiDAR system. According to one example, the beam shaper may be a conical lens pair that is disposed between an optical source and a steering device (e.g., a scanner) of the transmitter. The conical lens pair may include a pair of conical lenses arranged along the light path of the transmitter. Each conical lens may include a flat or planar surface on one side and a cone-shaped surface opposite to the flat surface. The cone-shaped surface may have a predefined slope and the apex of the cone-shaped surface may be aligned with the center of a laser beam emitted by the LiDAR system. The two cone-shaped surfaces of the two conical lenses may face each other when the two optical lenses are aligned along the light path of the transmitter. The two flat surfaces of the two optical lenses may be in parallel with each other and face away from each other. The flat surfaces are perpendicular to the light path or the center of an emitted laser beam. The two optical lenses may have a cylinder base and the centers of the two optical lenses may share a same axis when aligned in tandem along the light path with the transmitter.

The LiDAR system may also include a photodetector array in the receiving end of the LiDAR system. The photodetector array may detect the optical signal returning from the environment by sections. That is, the returned optical signal may be divided into multiple sections when detected by a corresponding photodetector or photosensor in the photodetector array. If there is no conical lens pair in the LiDAR system, the returned optical signal may be nonuniform due to the Lambertian effect, which then causes some sections (e.g., edge sections) of the returned signal to have a lower intensity or even completely lose the signal when detected by a photodetector channel in the detector array. Therefore, the image obtained by a LiDAR system may be distorted.

In the present disclosure, by introducing a conical lens pair in the transmitter, the disclosed LiDAR system may compensate for the nonuniformity of the reflected optical signal caused by the Lambertian effect by providing a redistributed laser source, which also has a nonuniformity but in an opposite way. The included conical lens pair may cause a redistribution of a laser beam emitted by the laser source. The redistribution laser beam may have a higher intensity on the edges and a lower intensity in the center, which is opposite to the intensity nonuniformity caused by the Lambertian effect, and thus can compensate for the intensity nonuniformity caused by the Lambertian effect. Accordingly, the returning laser beam in the disclosed LiDAR system becomes more uniform. The optical loss may be thus prevented, and imaging distortion may be minimized, resulting in an improved image. The features and advantages described herein are not all-inclusive and many additional features and advantages will be apparent to one of ordinary skill in the art in view of the figures and the following descriptions.

The disclosed LiDAR system containing a conical lens pair can be used in many applications. For example, the disclosed LiDAR system can be used in advanced navigation technologies, such as to aid autonomous driving or to generate high-definition maps, in which the optical sensing system can be equipped on a vehicle.

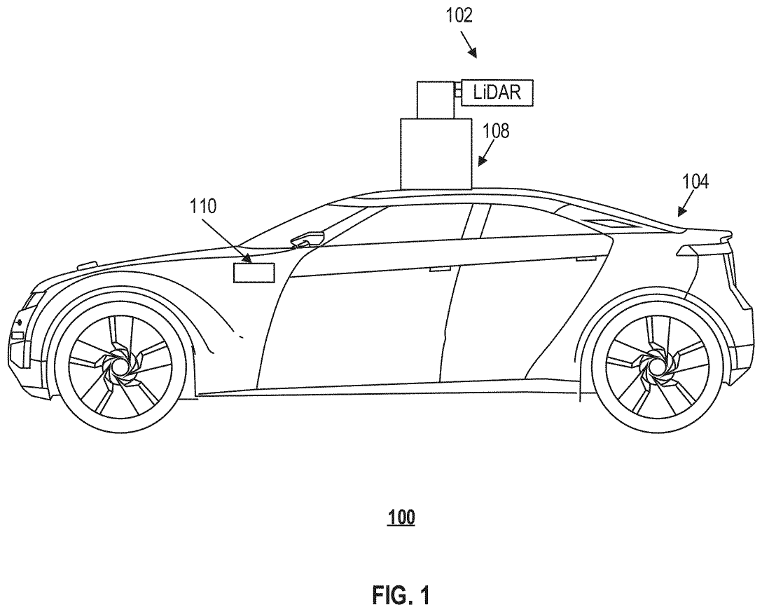

FIG. 1 illustrates a schematic diagram of an exemplary vehicle equipped with an optical sensing system containing a conical lens pair, according to embodiments of the disclosure. Consistent with some embodiments, vehicle 100 may be a survey vehicle configured for acquiring data for constructing a high-definition map or 3-D buildings and city modeling. Vehicle 100 may also be an autonomous driving vehicle.

As illustrated in FIG. 1, vehicle 100 may be equipped with an optical sensing system, e.g., a LiDAR system 102 (also referred to as “LiDAR system 102” hereinafter) mounted to a body 104 via a mounting structure 108. Mounting structure 108 may be an electro-mechanical device installed or otherwise attached to body 104 of vehicle 100. In some embodiments of the present disclosure, mounting structure 108 may use screws, adhesives, or another mounting mechanism. Vehicle 100 may be additionally equipped with a sensor 110 inside or outside body 104 using any suitable mounting mechanisms. Sensor 110 may include sensors used in a navigation unit, such as a Global Positioning System (GPS) receiver and one or more Inertial Measurement Unit (IMU) sensors. It is contemplated that the manners in which LiDAR system 102 or sensor 110 can be equipped on vehicle 100 are not limited by the example shown in FIG. 1 and may be modified depending on the types of LiDAR system 102 and sensor 110 and/or vehicle 100 to achieve desirable 3D sensing performance.

Consistent with some embodiments, LiDAR system 102 and sensor 110 may be configured to capture data as vehicle 100 moves along a trajectory. For example, a scanning system of LiDAR system 102 may be configured to scan the surrounding environment. LiDAR system 102 measures distance to a target by illuminating the target with laser beams and measuring the reflected/scattered pulses with a receiver. The laser beams used for LiDAR system 102 may be ultraviolet, visible, or near-infrared, and may be pulsed or continuous wave laser beams. In some embodiments of the present disclosure, LiDAR system 102 may capture point clouds including depth information of the objects in the surrounding environment, which may be used for constructing a high-definition map or 3-D buildings and city modeling. As vehicle 100 moves along the trajectory, LiDAR system 102 may continuously capture data including the depth information of the surrounding objects (such as moving vehicles, buildings, road signs, pedestrians, etc.) for map, building, or city modeling construction.

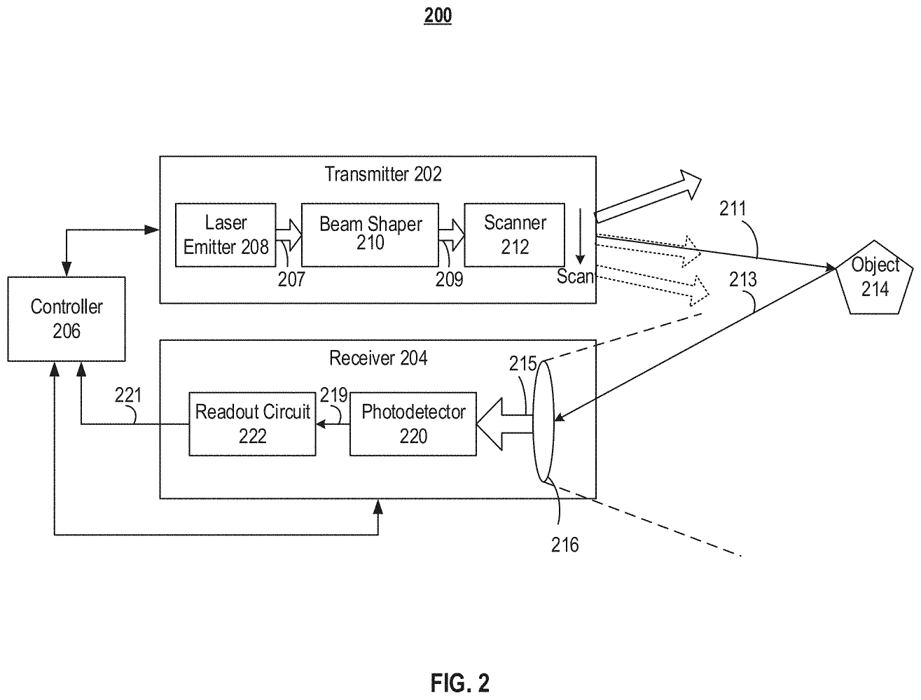

FIG. 2 illustrates a block diagram of an exemplary LiDAR system containing a conical lens pair, according to embodiments of the disclosure. In some embodiments, LiDAR system 102 may be a scanning flash LiDAR, a semi-coaxial LiDAR, a coaxial LiDAR, a biaxial LiDAR, etc. As illustrated, LiDAR system 102 may include a transmitter 202, a receiver 204, and a controller 206 coupled to transmitter 202 and receiver 204. Transmitter 202 may further include a laser emitter 208 for emitting an optical signal and a beam shaper 210 for shaping or redistributing the optical signal emitted by laser emitter 208. In some embodiments, transmitter 202 may additionally include a scanner 212 (also referred to as “steering device” consistent with the present disclosure) for steering the redistributed optical signal according to a certain pattern. Transmitter 202 may emit optical beams (e.g., pulsed laser beams, continuous wave (CW) beams, frequency modulated continuous wave (FMCW) beams) along multiple directions. Receiver 204 may further include a receiving lens 216, a photodetector 220, and a readout circuit 222.

Laser emitter 208 may be configured to emit laser beams 207 (also referred to as “native laser beams”) to beam shaper 210. For instance, laser emitter 208 may generate laser beams in the ultraviolet, visible, or near-infrared wavelength range, and provide the generated laser beams to beam shaper 210. In some embodiments of the disclosure, depending on underlying laser technology used for generating laser beams, laser emitter 208 may include one or more of a double heterostructure (DH) laser emitter, a quantum well laser emitter, a quantum cascade laser emitter, an interband cascade (ICL) laser emitter, a separate confinement heterostructure (SCH) laser emitter, a distributed Bragg reflector (DBR) laser emitter, a distributed feedback (DFB) laser emitter, a vertical-cavity surface-emitting laser (VCSEL) emitter, a vertical-external-cavity surface-emitting laser (VECSEL) emitter, an extern-cavity diode laser emitter, etc., or any combination thereof. Depending on the number of laser emitting units in a package, laser emitter 208 may include a single emitter containing a single light-emitting unit, a multi-emitter unit containing multiple single emitters packaged in a single chip, an emitter array or laser diode bar containing multiple (e.g., 10, 20, 30, 40, 50, etc.) single emitters in a single substrate, an emitter stack containing multiple laser diode bars or emitter arrays vertically and/or horizontally built up in a single package, etc., or any combination thereof. Depending on the operating time, laser emitter 208 may include one or more of a pulsed laser diode (PLD), a CW laser diode, a Quasi-CW laser diode, etc., or any combination thereof. Depending on the semiconductor materials of diodes in laser emitter 208, the wavelength of incident laser beams 207 may be at different values, such as 760 nm, 785 nm, 808 nm, 848 nm, 870 nm, 905 nm, 940 nm, 980 nm, 1064 nm, 1083 nm, 1310 nm, 1370 nm, 1480 nm, 1512 nm, 1550 nm, 1625 nm, 1654 nm, 1877 nm, 1940 nm, 2000 nm, etc. It is understood that any suitable laser source may be used as laser emitter 208 for emitting laser beams 207 at a proper wavelength.

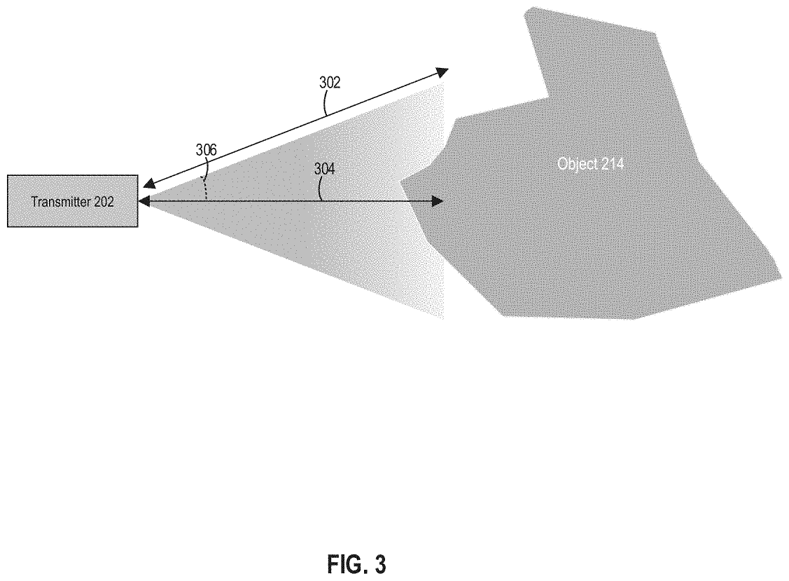

Beam shaper 210 may include optical components (e.g., lenses, mirrors) that can shape the laser light to redistribute the light intensity of a laser beam emitted by laser emitter 208. Scanner 212 may include various optical elements such as prisms, mirrors, gratings, optical phased array (e.g., liquid crystal-controlled grating), or any combination thereof. Object(s) 214 may be made of a wide range of materials including, for example, non-metallic objects, rocks, rain, chemical compounds, aerosols, clouds, and even single molecules. Consistent with embodiments of the disclosure, beam shaper 210 in LiDAR system 102 may include a conical lens pair that includes two conical lens elements arranged in tandem along the light path of transmitter 202. The conical lens pair may redistribute the intensity of laser beams emitted by laser emitter 208 to a certain pattern. For instance, the conical lens pair may redistribute the intensity of an emitted laser beam to a ring-shaped laser beam that has a higher intensity on the edges of the laser beam and a lower intensity in the center of the laser beam. More details about the conical lens pair and its function will be described later in FIGS. 3-8.

Receiver 204 may be configured to detect returned laser beams 213 returned from object 214. Upon contact, laser light can be reflected/scattered by object 214 via backscattering, such as Raman scattering, and fluorescence. Returned laser beams 213 may be in a same or different direction from laser beams 211. In some embodiments, receiver 204 may collect laser beams returned from object 214 and output signals reflecting the intensity of the returned laser beams.

As illustrated in FIG. 2, receiver 204 may include a receiving lens 216, a photodetector 220, and a readout circuit 222. Receiving lens 216 may be configured to converge and focus the returning optical signal on photodetector 220 as a focused laser beam 215.

Photodetector 220 may be configured to detect the focused laser beams 215. In some embodiments, photodetector 220 may convert a laser beam 215 into an electrical signal 219 (e.g., a current or a voltage signal). Electrical signal 219 may be an analog signal which is generated when photons are absorbed in a photodiode included in photodetector 220. In some embodiments, photodetector 220 may include a PIN detector, an avalanche photodiode (APD) detector, a single photon avalanche diode (SPAD) detector, a silicon photo multiplier (SiPM) detector, or the like. In some embodiments, photodetector 220 may include a plurality of photosensors or pixels arranged in a one-dimensional or two-dimensional array.

Readout circuit 222 may be configured to integrate, amplify, filter, and/or multiplex signal detected by photodetector 220 and transfer the integrated, amplified, filtered, and/or multiplexed signal 221 onto an output port (e.g., controller 206) for readout. In some embodiments, readout circuit 222 may act as an interface between photodetector 220 and a signal processing unit (e.g., controller 206). Depending on the configurations, readout circuit 222 may include one or more of a transimpedance amplifier (TIA), an analog-to-digital converter (ADC), a time-to-digital converter (TDC), or the like.

Controller 206 may be configured to control transmitter 202 and/or receiver 204 to perform detection/sensing operations. For instance, controller 206 may control laser emitter 208 to emit laser beams 207, or control photodetector 220 to detect optical signal returning from the environment. In some embodiments, controller 206 may also control data acquisition and perform data analysis. For instance, controller 206 may collect digitalized signal information from readout circuit 222, determine the distance of object 214 from LiDAR system 102 according to the travel time of laser beams, and construct a high-definition map or 3-D buildings and city modeling surrounding LiDAR system 102 based on the distance and/or depth information of object(s) 214.

As previously described, without a beam shaper 210, a returned laser beam in a LiDAR system may be nonuniform due to the Lambertian effect in the LiDAR system. FIG. 3 illustrates a schematic diagram of an exemplary scenario of a laser beam emitted onto a far-field object, according to embodiments of the disclosure. Due to the Lambertian effect, the reflected light for larger angle deflection is typically less than that from the center of the field of view (FOV) because of the tilted incident angle. The intensity of reflected signal (Iᵣ) is a combination of the intensity caused by the specular reflection (I_{d}) and the intensity caused by the diffuse reflection (Iₛ), which may be modeled by Equation (1) shown below:

$${I}_{r} = {I}_{d} + {I}_{s} = I ( \frac{{k}_{d} cos θ}{{R}^{2}} + \frac{{k}_{s} {cos}^{n} θ}{{R}^{2}} ) \qquad ( 1 )$$

Here, k_{d} is the diffuse reflection coefficient or the diffuse reflectivity that determines the fraction of incident light that is to be scattered as diffuse reflections from that surface. In some embodiments, k_{d} may be assigned a value between 0.0 and 1.0, where 0.0 represents a dull surface that absorbs almost all light while 1.0 represents a shiny surface that reflects almost all light. kₛ is the specular reflection coefficient or the specular reflectivity that determines the fraction of incident light that is to be scattered as specular reflections from that surface. In some embodiments, kₛ may be set to 1−k_{d}. The exponent n determines the sharpness of the specular light. θ is the incident angle, which may equal to angle 306 shown in FIG. 3 for the incident light indicated by arrow 302. For incident light indicated by arrow 304, the incident angle θ is 0. I is the incident power from the light source (e.g., laser beam emitted by laser emitter 208 in LiDAR system 102). R is the distance between the light source and the object. From the equation, it can be seen that the larger the distance R, the smaller the reflected signal, and vice versa.

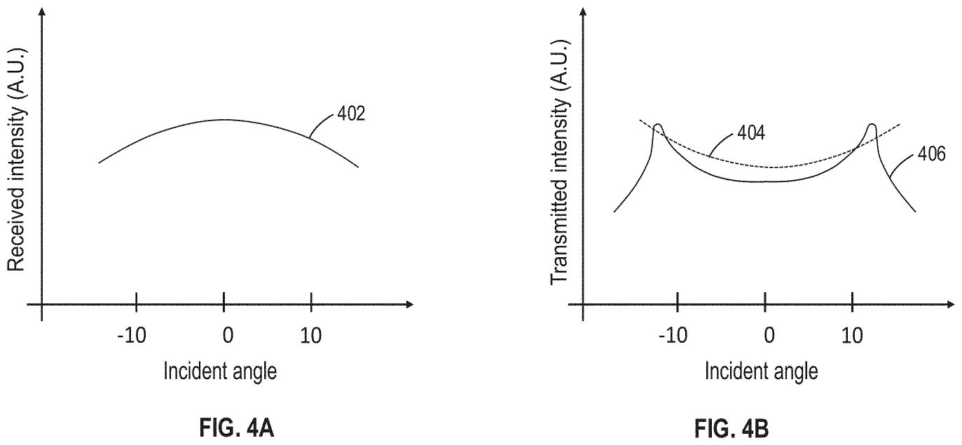

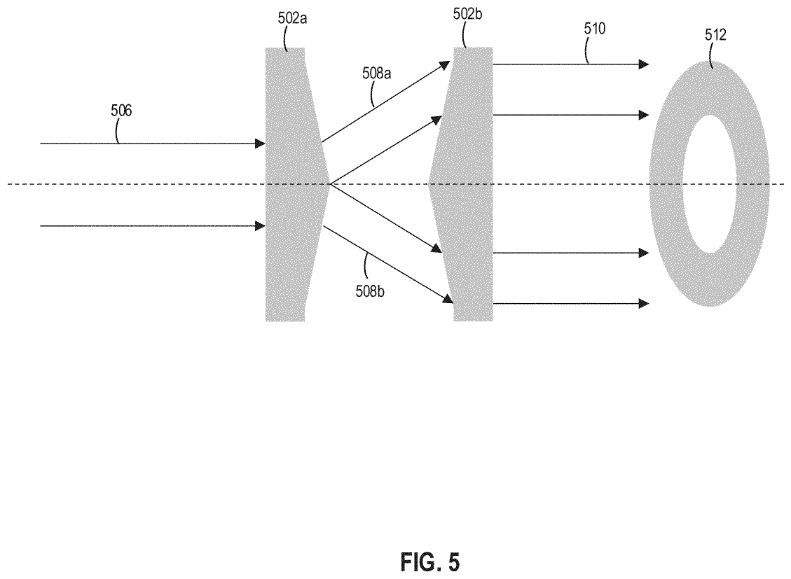

From Equation (1), it can be seen the light intensity of the reflected signal becomes smaller when the incident angle becomes larger. That is, the intensity of the reflected light indicated by arrow 302 is smaller than the intensity of the reflected light indicated by arrow 304. A representative profile of the intensity of the reflected signal with respect to the incident angle may be illustrated in FIG. 4A. As can be seen, the intensity of the reflected signal (or the received intensity by the photodetector array) is the largest when the incident angle is 0. When the incident angle becomes larger, the received intensity becomes smaller, as indicated by line 402 in FIG. 4A. To compensate for the nonuniform light distribution within the returned light, one possible option is to redistribute the incident light directed to the far-field object. For instance, by redistributing a laser beam emitted by laser emitter 208 in LiDAR system 102, the light returned from the far-field object may become more balanced or uniform. FIG. 4B illustrates an expected light profile for the light emitted from a laser source (e.g., from laser emitter 208 in LiDAR system 102). Line 404 in the figure may represent an expected light profile for the light incident on the far-field object that compensates for the nonuniform intensity within the returned light due to the Lambertian effect. Line 406 may represent a measured beam intensity profile after a conical lens pair is included in a transmitter. To achieve the expected light distribution profile as indicated by line 404, different mechanisms may be exploited. According to one embodiment, a beam shaper, such as a conical lens pair, may be employed, as described more in detail in FIG. 5.

FIG. 5 illustrates a schematic diagram showing an exemplary laser intensity redistribution effect caused by a conical lens pair, according to embodiments of the disclosure. As can be seen, the light intensity redistribution may be achieved by a conical lens pair that includes a first conical lens element 502a and a second conical lens element 502b. Each conical lens element 502a or 502b may be a circular lens or another shape of lens (e.g., square shape, ellipse shape, rectangular shape, etc.) that has a flat or planar surface on one side along the light path and a cone-shaped surface on the opposite side along the light path. Each cone-shaped surface may have a certain slope, which causes a light refraction when the light passes through the conical lens. For instance, when a light beam 506 passes through first conical lens element 502a, due to the refraction caused by the cone-shaped structure, the light may become divided at the apex of the cone-shaped surface of first conical lens element 502a, as indicated by arrows 508a and 508b. It is to be noted, while arrows 508a and 508b indicate that the light may be divided like a fork, in actual applications, the light may be divided in 360-degree directions around the apex, and thus may be divided in a circle format. For instance, the light may expand like a smoke ring after passing through first conical lens element 502a.

In some embodiments, to prevent the unlimited expansion of “smoke ring” and prevent the center “hole” (which may be not exactly a hole with no light but rather means that the center has less light intensity than the edges of the ring) from becoming too large, a second conical lens element 502b may be disposed at a proper distance away from first conical lens element 502a. Second conical lens element 502b may collimate the expanding “smoke ring” so that the light may be collimated again to a light beam 510. Light beam 510 may be different from light beam 506 due to the light redistribution. For instance, as illustrated, light beam 510 may have a ring-shaped intensity distribution as indicated by ring 512 in FIG. 5.

As illustrated in FIG. 5, the two conical lens elements 502a and 502b may have the same shape and structure. For instance, the two conical lens elements 502a and 502b may have a same slope on the cone-shaped surfaces. In addition, the two conical lens elements 502a and 502b may be made out of a same material and thus have a same refraction index. In some alternative embodiments, the two conical lens elements 502a and 502b may be not exactly the same but rather have different shapes and structures. For instance, the two conical lens elements 502a and 502b may have different slopes for the cone-shaped surfaces. Likewise, the refraction indexes of the two conical lens elements 502a and 502b may be also configured to be different, as long as the combination of the slopes of the refraction indexes of the two conical lens elements 502a and 502b still allows a laser beam passing through the conical lens pair to remain in a same direction after light redistribution by the conical lens pair.

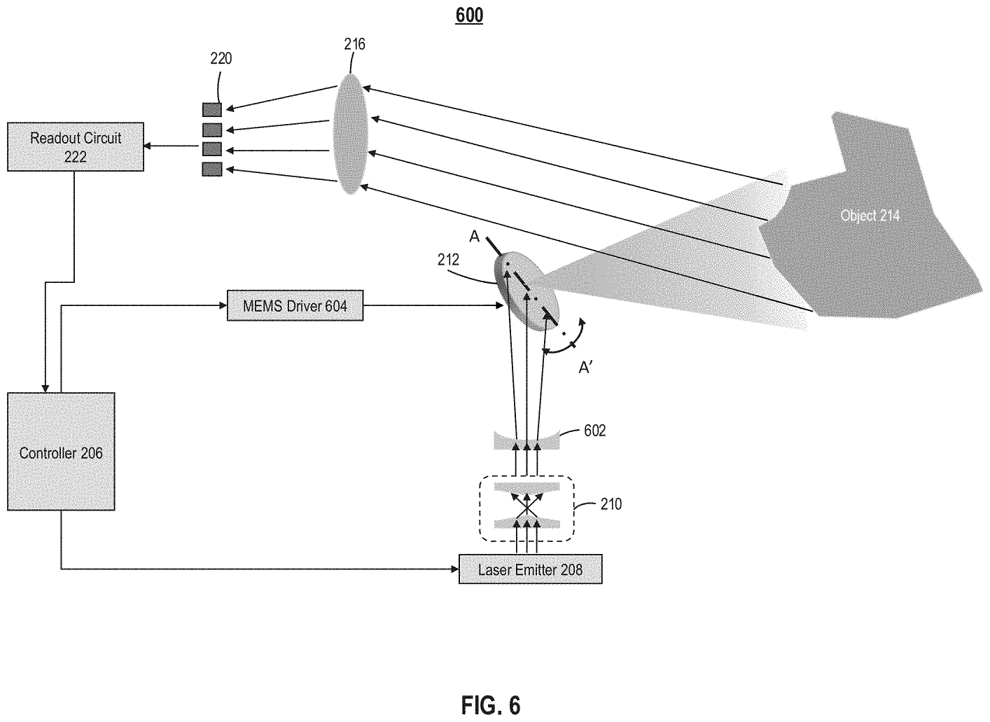

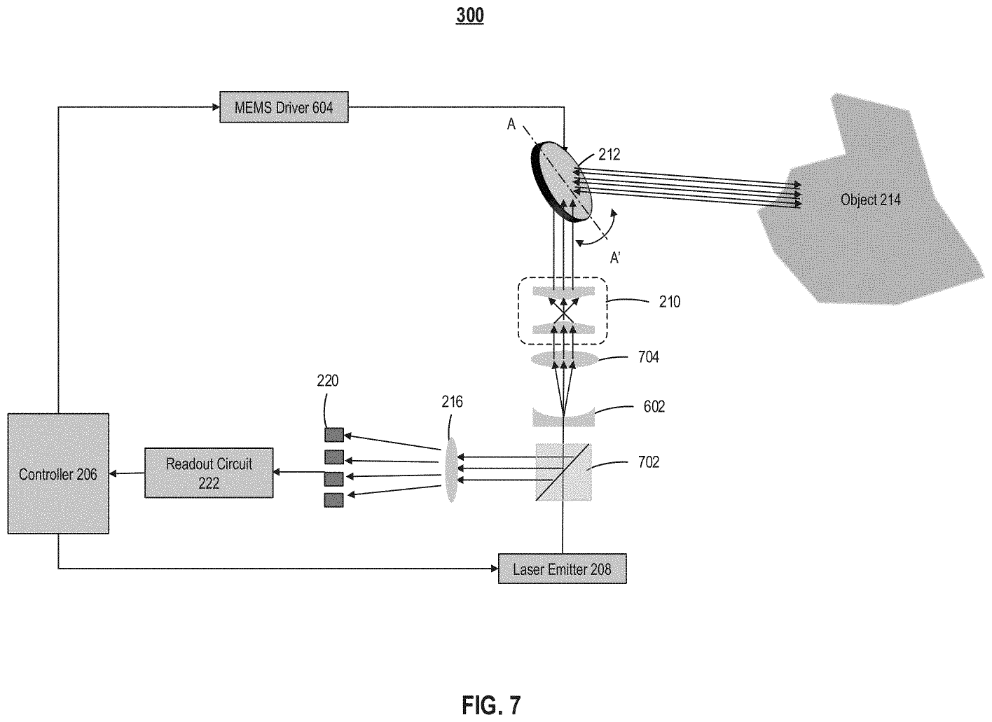

As also illustrated in FIG. 5, the two conical lens elements 502a and 502b may be aligned in tandem along the light path with the two cone-shaped surfaces of the two conical lens elements facing each other. In some embodiments, the distance between the two conical lens elements 502a and 502b may determine the shape of ring 512 and thus the light intensity redistribution (or simply “light redistribution”) of laser beam 510. To allow achievement of a light redistribution as shown by line 404 or line 406 in FIG. 4B, the two conical lens elements 502a and 502b may need to have a precise distance. The exact distance between the two conical lens elements 502a and 502b may be determined based on a variety of factors. For instance, factors that affect the Lambertian effect of a far-field object may also play a role in determining the distance between the two conical lens elements 502a and 502b. These factors may include the divergence of a laser beam emitted by laser emitter 208, the size of the emitted laser beam, the diffuse reflection coefficient k_{d}, the specular reflection coefficient kₛ, and so on. Other factors that may affect the expected distance between the two conical lens elements 502a and 502b may also include the slopes of the cone-shaped surfaces of the two conical lens elements 502a and 502b, the refraction indexes of the two conical lens elements 502a and 502b, and so on. After determining the expected distance between the two conical lens elements 502a and 502b, the conical lens pair may be then placed after a laser source (e.g., laser emitter 208 of LiDAR system 102) along the light path, as shown in FIGS. 6-7.

FIG. 6 illustrates a schematic diagram of an exemplary biaxial LiDAR system containing a conical lens pair, according to embodiments of the disclosure. As illustrated in the figure, after alignment at a determined distance, the two conical lens elements 502a and 502b may be placed as a beam shaper 210 after laser emitter 208 but before scanner 212. Organized in this way, after light redistribution of a laser beam emitted by laser emitter 208, the redistributed laser beam may be directed towards object 214. Object 214 may be a far-field object that reflects the redistributed laser beam under the Lambertian effect. As the intensity redistribution caused by the conical lens pair tends to compensate for the intensity nonuniformity caused by the Lambertian effect, the returned laser beam reflected by object 214 may become more uniform.

As shown in the figure, besides laser emitter 208, beam shaper 210, scanner 212, and photodetector array 220, the illustrated biaxial LiDAR system 102 may further include a controller 206, a receiving lens 216, a readout circuit 222, a beam expander 602, and a micro-electromechanical system (MEMS) driver 604. Controller 206, receiving lens 216, and readout circuit 222 may have similar functions as the respective components illustrated in FIG. 2, detail of which will not be repeated again here. Beam expander 602 may expand an emitted laser beam to a larger size, as shown in FIG. 6. The inclusion of beam expander 602 may allow a proper size of a laser beam to be achieved. It is to be noted that while beam expander 602 is placed after beam shaper 210 in FIG. 6, in some embodiments, beam expander 602 may be also placed before beam shaper 210. MEMS driver 604 may be configured to drive the rotation of scanner 212. For instance, based on information obtained from controller 106, MEMS driver 604 may drive scanner 212 to rotate (e.g., around axis AA′) towards different directions, to achieve a one-dimensional, two-dimensional, or even three-dimensional scanning.

While FIG. 6 illustrates a conical lens pair included in a biaxial LiDAR system, in real applications, the disclosed conical lens pair may be applied to many other LiDAR systems, such as coaxial LiDAR systems, semi-axial LiDAR systems, etc., for light intensity redistribution.

FIG. 7 illustrates a schematic diagram of an exemplary coaxial LiDAR system containing a conical lens pair, according to embodiments of the disclosure. As illustrated, the conical lens pair may be placed right before steering device 212 as a beam shaper 210. In addition, the illustrated coaxial LiDAR system may also include a beam splitter 702, a beam expander 602, a collimation lens 704, a MEMS driver 604, a receiving lens 216, a photodetector array 220, a readout circuit 222, and a controller 206. Beam expander 602, collimation lens 704, MEMS driver 604, receiving lens 216, photodetector array 220, readout circuit 222, and controller 206 may have similar functions as previously described, detail of which will not be repeated again here. Beam splitter 702 may separate returning laser beams reflected by objects in the environment from the outgoing laser beams emitted by laser emitter 208. As illustrated, since beam splitter 702 is placed right after laser emitter 208 along the light path, both outgoing laser beams and returning laser beams need to pass through the conical lens pair. Since the two conical lens elements in the conical lens pair are identical, the light intensity of a returning laser beam may be redistributed again due to the refraction caused by the cone-shaped surfaces of the conical lens pair. That is, when the returning laser beams are detected by photodetector array 220, the laser beams have been redistributed twice, once in the outgoing light path and once in the returning light path. This is different from a biaxial LiDAR system shown in FIG. 6, in which there is only one light redistribution.

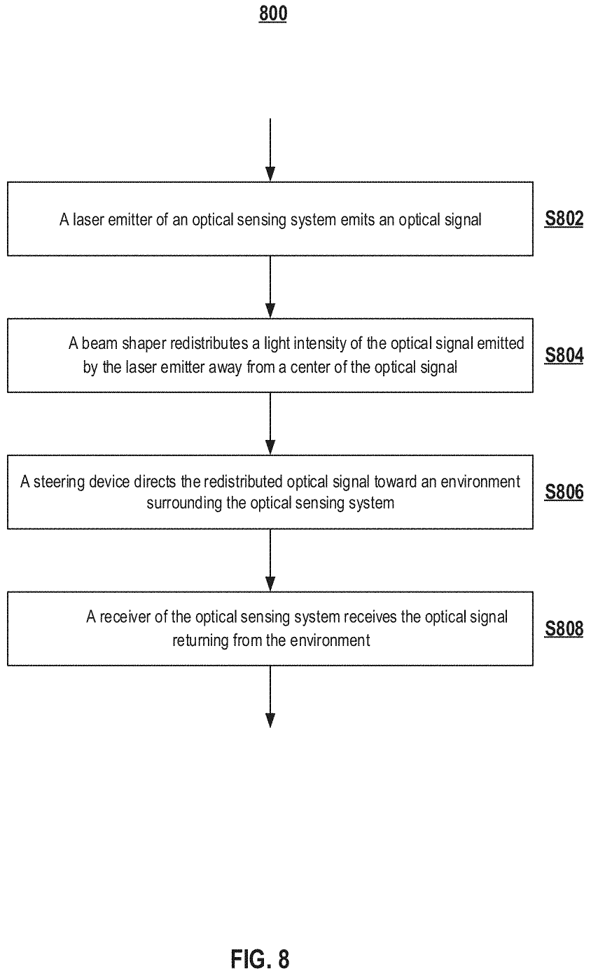

Since there are two light distributions caused by the conical lens pair in a coaxial LiDAR system shown in FIG. 7, each light redistribution may need to only partially compensate for the intensity nonuniformity caused by the Lambertian effect of a far-field object (e.g., object 214). For instance, each light redistribution may only need to compensate for a square root of the light nonuniformity caused by the Lambertian effect of the far-field object 214, so that two light redistributions may collectively compensate for the full extent of the light nonuniformity caused by the Lambertian effect. One way to achieve this is to adjust the distance between the two conical lens elements in the conical lens pair. For instance, the distance between the two conical lens elements included in the beam shaper 210 may be decreased, e.g., to a square foot of the distance as determined in FIG. 6 for a biaxial LiDAR system if other features/configurations (e.g., laser emitter 208, beam shaper 210) between the biaxial and coaxial LiDAR systems remain the same. In some embodiments, with or without additional distance adjustment for the inter-lens distance, the disclosed conical lens pair may be applied to many other LiDAR systems, or even other imaging systems that rely on a detector array to achieve a sub-pixelization for improved imaging resolution. The benefits of the disclosed conical lens pair for improved image resolution may be further illustrated through an exemplary optical sensing method as illustrated in FIG. 8.

FIG. 8 is a flow chart of an exemplary optical sensing method 800 performed by a LiDAR system containing a conical lens pair, according to embodiments of the disclosure. In some embodiments, method 800 may be performed by various components of LiDAR system 102, e.g., transmitter 202 containing a conical lens pair, receiver 204, and/or controller 206. In some embodiments, method 800 may include steps S802-S808. It is to be appreciated that some of the steps may be optional. Further, some of the steps may be performed simultaneously, or in a different order than that shown in FIG. 8.

In step S802, an optical source (e.g., laser emitter 208) inside a transmitter of an optical sensing system (e.g., transmitter 202 of LiDAR system 102) may emit an optical signal for optical sensing of the environment. Here, the optical signal emitted by the optical source may have a predetermined beam size and intensity. In some embodiments, the light intensity of the emitted optical signal may be uniform. That is, the light intensity on the edges of the optical signal may be substantially the same as the light intensity in the center of the optical signal emitted by the optical source.

In step S804, a beam shaper (e.g., beam shaper 210 of LiDAR system 102) may shape or redistribute the optical signal emitted by the laser source. The beam shaper may include two identical conical lens elements that each has a flat or planar surface on one side and a cone-shaped surface on the opposite side along the light path. The two conical lens elements may redistribute the light intensity of the emitted optical signal away from the center of the optical signal and towards the edges of the optical signal. This may compensate for the light intensity nonuniformity (e.g., the reflected optical signal has a lower intensity on the edges than in the center) caused by the Lambertian effect inherent to the light reflected by a far-field object. In some embodiments, the beam shaper may also redistribute the optical signal returned from the environment when the beam shaper also stands in the light path of the returned optical signal (e.g., when the beam shaper is placed right before a steering device in a coaxial LiDAR system).

In step S806, a steering device (e.g., scanner 212 in transmitter 202 of LiDAR system 102) may steer the redistributed optical signal out from the beam shaper toward the environment surrounding the optical sensing system. The steering device may steer the redistributed optical signal according to a predefined scanning pattern, so that different parts of the environment may be scanned over a short period of time. For instance, the redistributed optical signal may be directed towards a far-field object in the environment (e.g., object 214 in FIG. 2).

In step S808, a receiver (e.g., receiver 204) of the optical sensing system may receive the optical signal reflected from the environment (e.g., from a far-field object). The receiver may include a photodetector array that detects the returned optical signal in multiple sections. This allows a sub-pixelization to be achieved. If there is no beam shaper in the optical sensing system, the far-field object may reflect a nonuniform optical signal back to the photodetector array due to the Lambertian effect, which may result in an optical loss and thus distorted imaging. However, due to the introduction of the beam shaper in the disclosed optical system, the light incident on the far-field object may have a higher intensity on the edges of a lighted area when compared to the center of the lighted area on the object, and thus may compensate for the light intensity nonuniformity later caused by the Lambertian effect. Therefore, the returned optical signal may be much more uniform. Accordingly, the photodetector array may detect the returned optical signal by sections with a decreased or minimized optical loss on the edges of the returned optical signal, thereby allowing achievement of a sub-pixelization with improved quality of imaging (or mapping).

Although the disclosure is made using a LiDAR system as an example, the disclosed embodiments may be adapted and implemented to other types of optical sensing systems that use receivers to receive optical signals not limited to laser beams. For example, the embodiments may be readily adapted for optical imaging systems or radar detection systems that use electromagnetic waves to scan objects.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor-based, tape-based, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. An optical sensing system, comprising:
a transmitter, configured to emit an optical signal toward an environment surrounding the optical sensing system; and
a receiver, configured to receive the optical signal returning from the environment,
wherein the transmitter comprises:
a laser emitter, configured to emit the optical signal;
a beam shaper, configured to receive the optical signal emitted by the laser emitter and redistribute a light intensity of the received optical signal away from a center of the optical signal; and
a steering device, configured to receive the redistributed optical signal output from the beam shaper and direct the redistributed optical signal toward the environment.

2. The optical sensing system of claim 1, wherein the beam shaper comprises a pair of conical lenses arranged in tandem along a light path of the optical signal.

3. The optical sensing system of claim 2, wherein each of the pair of conical lenses comprises a cone-shaped surface and an opposite flat surface.

4. The optical sensing system of claim 3, wherein the cone-shaped surfaces of the pair of conical lenses face each other and the flat surfaces of the pair of conical lenses face away from each other when the pair of conical lenses are aligned in tandem along the light path of the optical signal.

5. The optical sensing system of claim 3, wherein each cone-shaped surface of the pair of conical lenses has a same slope.

6. The optical sensing system of claim 2, wherein the pair of conical lenses have a same refraction index.

7. The optical sensing system of claim 1, further comprising a beam expander disposed between the laser emitter and the beam shaper, wherein the beam expander is configured to expand a beam size of the optical signal emitted by the laser emitter.

8. The optical sensing system of claim 1, wherein the redistributed optical signal has a higher light intensity at edges of a lighted area and a lower light intensity at a center of the lighted area when the redistributed optical signal reaches a far-field object in the environment.

9. The optical sensing system of claim 1, wherein the receiver comprises a photodetector array configured to detect the optical signal returning from the environment, wherein the optical signal detected by the photodetector array has a substantially uniform light intensity profile.

10. The optical sensing system of claim 1, wherein an arrangement of the transmitter and the receiver is one of a coaxial arrangement or a biaxial arrangement.

11. An optical sensing method, comprising:
emitting, by a laser emitter of an optical sensing system, an optical signal toward an environment of the optical sensing system;
redistributing, by a beam shaper of the optical sensing system, a light intensity of the received optical signal emitted by the laser emitter away from a center of the optical signal, wherein the beam shaper comprises a conical lens pair aligned in tandem along a light path of the optical signal;
directing, by a steering device of the optical sensing system, the redistributed optical signal toward the environment; and
receiving, by a receiver of the optical sensing system, the optical signal returning from the environment, wherein the receiver comprises a photodetector array.

12. The optical sensing method of claim 11, wherein directing the redistributed optical signal toward the environment comprises:
directing the redistributed optical signal towards a far-field object in the environment, wherein the redistributed optical signal has a higher light intensity at edges of a lighted area and a lower light intensity at a center of the lighted area when the redistributed optical signal reaches the far-field object.

13. The optical sensing method of claim 11, wherein receiving the optical signal from the environment comprises:
receiving the optical signal by a photodetector array included in the receiver of the optical sensing system, wherein the optical signal received by the photodetector array has a substantially uniform light intensity profile.

14. The optical sensing method of claim 11, wherein, before redistributing the light intensity of the received optical signal, the method further comprises:
expanding, by a beam expander of the optical sensing system, a beam size of the optical signal emitted by the laser emitter.

15. A transmitter for an optical sensing system, comprising:
a laser emitter, configured to emit an optical signal;
a beam shaper, configured to receive the optical signal emitted by the laser emitter and redistribute a light intensity of the received optical signal away from a center of the optical signal; and
a steering device, configured to receive the redistributed optical signal output from the beam shaper and direct the redistributed optical signal toward an environment.

16. The transmitter of claim 15, wherein the beam shaper comprises a pair of conical lenses arranged in tandem along a light path of the optical signal.

17. The transmitter of claim 16, wherein each of the pair of conical lenses comprises a cone-shaped surface and an opposite flat surface.

18. The transmitter of claim 17, wherein the cone-shaped surfaces of the pair of conical lenses face each other and the flat surfaces of the pair of conical lenses face away from each other when the pair of conical lenses are aligned in tandem along the light path of the optical signal.

19. The transmitter of claim 17, further comprises a beam expander disposed between the laser emitter and the beam shaper, wherein the beam expander is configured to expand the beam size of the optical signal emitted by the laser emitter.

20. The transmitter of claim 17, wherein the redistributed optical signal has a higher light intensity at edges of a lighted area and a lower light intensity at a center of the lighted area when the redistributed optical signal reaches a far-field object in the environment.
